(19) United States
(12) Patent Application Publication
(10) Pub. No.: US 2002/0077922 A1
(43) Pub. Date: Jun. 20, 2002

(54) System, method, and article of manufacture for mass customization of products

(76) Inventor: Ramanujam Srinivasan, Los Altos, CA (US)

Correspondence Address: OPPENHEIMER WOLFF & DONNELLY, P. O. BOX 10356, PALO ALTO, CA, 94303, US

(21) Appl. No.: 09/738,531

(22) Filed: Dec. 15, 2000

(51) Int. Cl. G06F 17/60

(52) U.S. Cl. 705/26

(57) ABSTRACT

A method is afforded for providing mass customization of products. Body dimension data associated with a user is collected. This body dimension data includes at least one of a plurality of measurements of at least one of a plurality of parts of a body of the user. The data collected is stored in a database. The data collected is processed. This processing generates additional value that allows a merchant to readily use the data. The processed data is then stored in a database. The merchant is then allowed to access the processed data in the database.

### FIELD OF THE INVENTION

The present invention relates to e-commerce and more particularly to providing mass customization of personal products.

### BACKGROUND OF THE INVENTION

Although American consumers will spend $200 billion on clothes this year, 51% of apparel buyers in the United States say that they cannot find the right size in clothing that they like. The same situation undoubtedly exists in other countries and in virtually every industry. Current mass production does not leave room for consumers to customize products according to individual needs.

Mass customization of products at the individual level is non-existent. For example, the apparel industry manufactures clothing in a broad range of sizes, but there is no attempt to customize clothes to suit individual body dimensions and preferences. Continuing with the above example, there is no method or capability to collect information about individual body measurements in an efficient and comprehensive manner at a mass level, and to transmit this information to, for example, the designer, tailor, or manufacturer on a global basis. Additionally, there is no method for accurate body measurement and interaction between the individual consumer and a mass producer, or a tailor or designer as in the above example, when the two parties are not at the same geographic location.

Prior attempts to solve the problem of mass customization have been largely unsuccessful. Garment sizing systems require methods such as outfitting the customer in body suits with attached Velcro (TM) measuring tapes, having the customer try on partially finished clothing, and using video cameras to capture images. These solutions are based on manual input of data by sales clerks, interpreting camera or video photographs for body dimensions, or the assumption that the customer is knowledgeable enough about apparel design to alter a computer image of a desired garment to suit individual choices. Although these methods achieve the goal of tailoring clothing to the customer, they are fairly cumbersome and imprecise. In addition, these prior methods offer no solution to mass customization of other lifestyle-related applications on a global scale.

Manufacturers attempt to meet the needs of consumers by offering a broad range of sizes and dimensions for products. For example, a size 8 in clothing may always have a 28″ waist. As the size increases, the waist measurement will increase in varied increments. However, a consumer who finds that size 8 is a good fit across the bust may want a tighter fit at the waist, or a shorter length. At present, such a consumer does not have the option of customizing his or her choice of garment in a particular brand. Similarly, sporting equipment is available in standardized sizes or dimensions. But the option of mass-customizing the sporting equipment to obtain the proper fit does not exist. The ranges provided by manufacturers meet some consumer's needs. However, many consumers are forced to choose a size or product dimension that does not perfectly fit their needs. Thus, there is a need for a method that allows mass customization of products on the individual level.

The present invention solves the problem of mass customization on a global scale through a system of accurate body measurements and a network that can be accessed by, and enable swift interaction between customers, and designers, tailors, and manufacturers located worldwide.

### SUMMARY OF THE INVENTION

It is an object of the present invention to provide a method for mass-customization of products on a global scale.

Another object of the invention is to enable swift interaction between customers, and designers, tailors, and manufacturers located worldwide.

Another object of the invention is to allow designers, tailors, or manufacturers to obtain accurate body measurements of individual customers.

Another object of the invention is to help designers, tailors, or manufacturers create products that are customized, taking individual dimensions and preferences into account.

Another object of the invention is to give customers the ability to choose from designers, tailors, or manufacturers, and brands or labels, all over the world.

Another object of the invention is to allow customers to order from a catalog or gallery of creations, or to design his or her apparel, footwear, or other life-style-related product.

Another object of the invention is to suggest designers, tailors, or manufacturers that are most appropriate for a customer's body dimensions or individual preferences.

Another object of the invention is to allow users to order customized gifts for other individuals.

Another object of the invention is to ensure that a user's personal information remains confidential unless release of pertinent information is authorized by the user.

Another object of the present invention is to give the user the ability to control the level of personal information that is shared with designers, tailors, or manufacturers.

Briefly, one preferred embodiment of the present invention is a method for providing mass customization of products. Body dimension data associated with a user is collected. This body dimension data includes at least one measurement of at least one part of the body of the user. The data collected is stored in a database. The data collected is processed to generate additional value that allows a merchant to readily use the data. The processed data is then stored in the database. Finally, the merchant is allowed to access the data in the database.

These and other advantages of the present invention will become apparent to those skilled in the art upon a reading of the following descriptions of the invention and a study of the several figures of the drawings.

### BRIEF DESCRIPTION OF THE DRAWINGS

The invention will be better understood when consideration is given to the following detailed description thereof. Such description makes reference to the annexed drawings wherein:

FIG. 1 is a flowchart illustrating a process for mass customization in accordance with an embodiment of the present invention;

FIG. 2 is a schematic diagram of a hardware implementation of one embodiment of the present invention;

FIG. 3 is a schematic diagram illustrating a body dimension usage process in accordance with an embodiment of the present invention;

FIG. 4 is a schematic diagram illustrating a process for allowing communication between the merchant and the user in accordance with an embodiment of the present invention;

FIG. 5 is a schematic diagram illustrating a process for delivery of a customized product in accordance with an embodiment of the present invention;

FIG. 6 is a flowchart illustrating a process for restricting access to the database in accordance with an embodiment of the present invention;

FIG. 7A is a screen capture showing a custom tailoring display in accordance with an embodiment of the present invention;

FIG. 7B is a screen capture showing a user selected display item in accordance with an embodiment of the present invention;

FIGS. 7C and 7D are screen captures showing custom tailor information in accordance with an embodiment of the present invention;

FIG. 7E is a screen capture showing a custom tailoring order summary in accordance with an embodiment of the present invention;

FIG. 7F is a screen capture showing a custom tailoring confirmation page in accordance with an embodiment of the present invention;

FIG. 8A is a screen capture showing a web page of a custom tailor in accordance with an embodiment of the present invention;

FIG. 8B is a screen capture showing a user selected display item in accordance with an embodiment of the present invention;

FIG. 8C is a screen capture showing an order confirmation and display in accordance with an embodiment of the present invention;

FIG. 8D is a screen capture showing a login page for a user selecting to order the item utilizing the custom fit measurements from the service provider in accordance with an embodiment of the present invention;

FIG. 8E is a screen capture showing an authorization page in accordance with an embodiment of the present invention; and

FIG. 8F is a screen capture showing a confirmation message in accordance with an embodiment of the present invention.

### DETAILED DESCRIPTION OF THE PREFERRED EMBODIMENTS

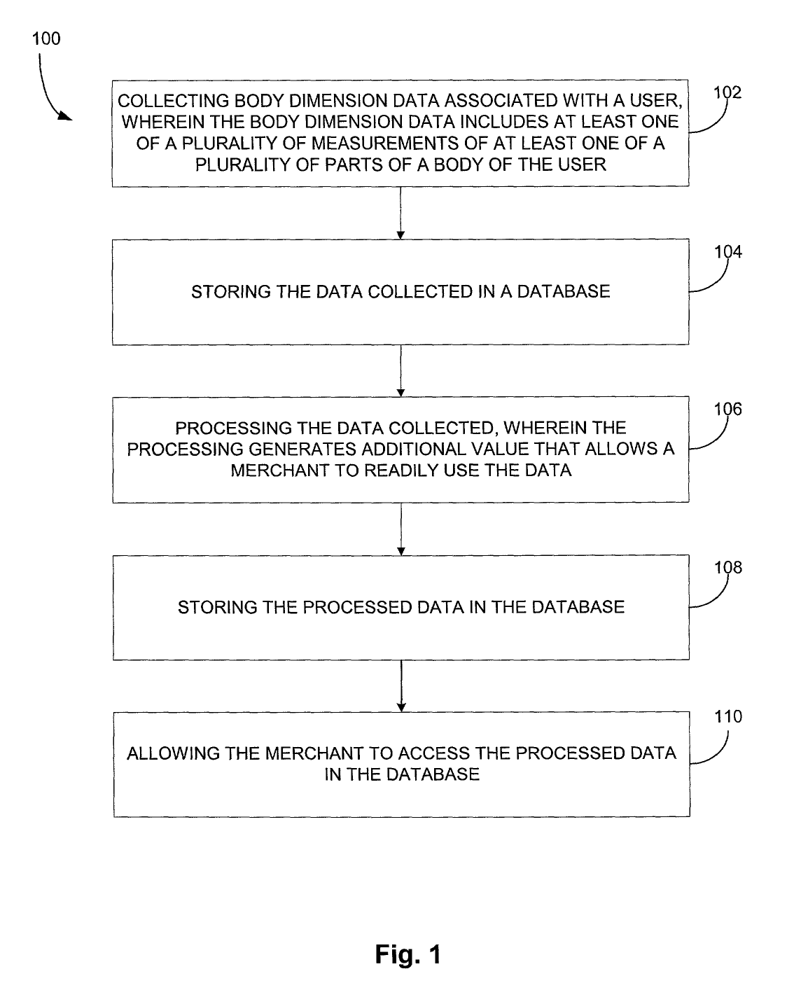

FIG. 1 is a flowchart illustrating a process 100 for mass customization in accordance with an embodiment of the present invention. In operation 102, body dimension data associated with a user is collected. This body dimension data includes at least one measurement of at least one part of the body of the user. In operation 104, the data collected is stored in a database. The data collected is processed in operation 106. This processing generates additional value that allows a merchant to readily use the data. In operation 108, the processed data is then stored in the database. The merchant is then allowed to access the processed data in the database in operation 110, for use in meeting the users needs.

Body dimension data may be collected by a body scanner or measurements may be obtained manually. The measurements obtained manually may include measurements obtained in response to a questionnaire provided to the user.

The user can place an order with the merchant. The merchant may access the data in the database utilizing a user order number received through a communication associated with an order of the user. Various options may be added to such an order including special requirements, comments, a description of a product, a nature of customization desired by the user or their personal fit preferences. The data accessed by the merchant can also be utilized to update the status of an order by the user.

The merchant can communicate with the user by sending a communication to the database where it can then be routed to the user. The user can similarly reply to the communication.

Information associated with the merchant may also be collected and stored in the database. This may include suggestions to the user of the merchant appropriate for the services sought. This suggestion may be dependent upon body type, location, specialty, or user preferences. The user can also search the database for the merchant the user desires for the services sought.

The database may be a centralized database accessible from any location. The user may authorize which of the plurality of measurements the merchant can access from the database. The database can also be updated based on body dimension data from a repeat body scan, body measurements obtained manually, or individual fit preferences in another embodiment of the present invention.

A unique identifier may be assigned to the user or the merchant to allow access to the database. The user or the merchant may access the database by presenting the unique identifier. Which of the plurality of measurements the merchant can access from the database may be verified upon presentation of the unique identifier of the merchant. The user or the merchant can go through a registration process in order to receive the unique identifier.

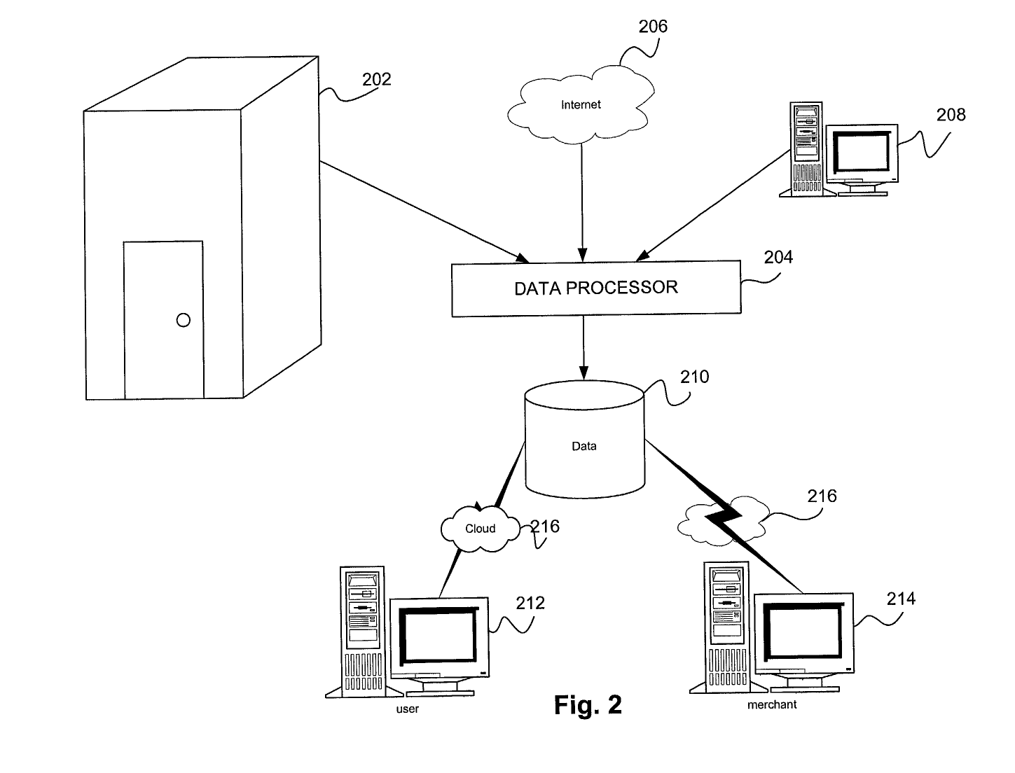

FIG. 2 is a schematic diagram of a hardware implementation of the present invention. Scanners located inside a scanning booth 202 may collect body dimension data related to a user. The body dimension data collected can be sent to a data processor 204. The data processor can be any type of computer or device that processes data to accomplish the intended function.

As an option, body dimension data may be collected from the user via the Internet 206. In this option, the data can be collected by having the user complete an online questionnaire. As another option, data may be collected from a computer 208 of the merchant, the user, or the service provider. The service provider in this option may be the entity collecting and processing the data. In this option, the user may complete a questionnaire manually or otherwise manually enter body dimensions or measurements. The results of the questionnaire may then be entered into the computer 208 and sent to the data processor 204.

The data can be stored in a database 210. This database 210 may be accessed by the user 212 or by the merchant 214. The merchant 214 or the user 212 may access the database 210 via a network 216. The network 216 may be a wide area network (WAN), such as the Internet. As an option, the network 216, may be a local area network (LAN). As a further option, the network 216, may be a virtual private network (VPN).

All three types of networks may be utilized in the process of accessing the database 210, or any combination thereof. For example, a shopping mall with a LAN may be connected via a WAN, such as the Internet, to multiple merchants. The shopping mall can permit multiple merchants to securely access the database via the VPN.

The data may be processed by using the raw data generated from the scans or from the online questionnaires, manual questionnaires, or manual body dimensions or measurements entered. The raw data is processed to generate an additional value. The additional value generated creates data that is readily useable by the merchant from the raw data.

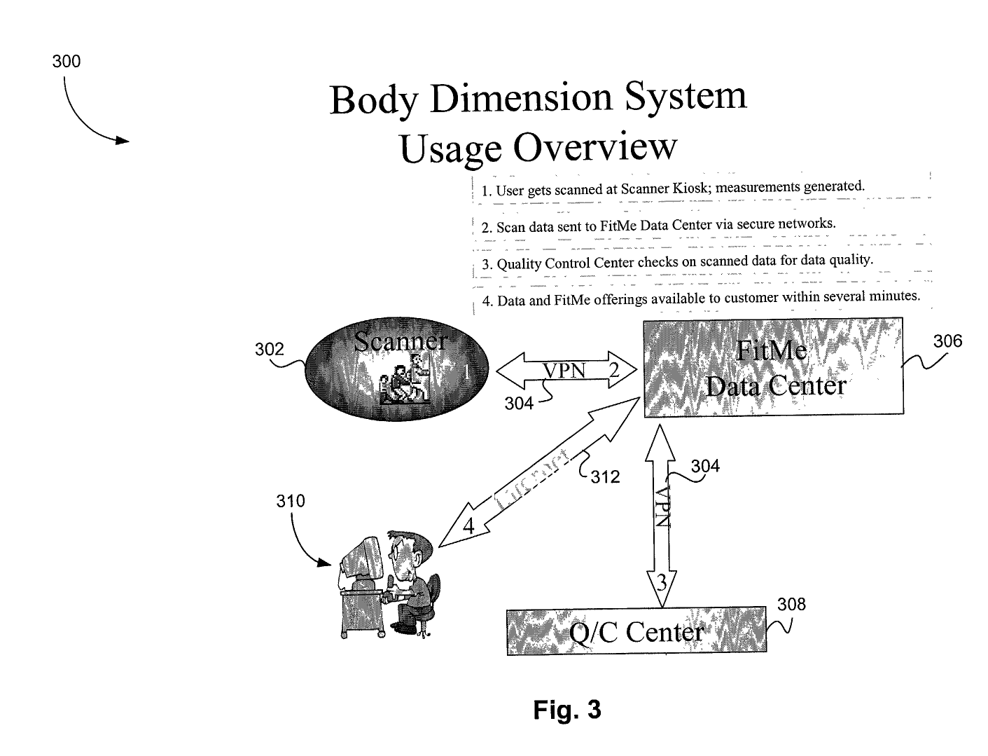

FIG. 3 is a schematic diagram illustrating a body dimension usage process 300 in accordance with an embodiment of the present invention. A scanner 302 may be used to scan the user. The user may be scanned at a scanner kiosk, where measurements may be generated associated with the user being scanned. Utilizing a virtual private network (VPN) 304, the data generated from the scanner may be securely sent to a data center 306. The data from the data center 306 may be sent to a quality control center 308. This data may also be sent utilizing a VPN 304. The quality control center 308 may check the data for data quality. The data will then be sent back to the data center 306 once it has been checked for this data quality. Subsequently, the customer 310 may access the data in the data center 306. The customer 310 may access this data via the Internet 312. This customer 310 may be an individual or a business.

The process may include obtaining, processing and storing data from a plurality of recipients, obtaining from the user a description of a product and the nature of customization desired, assigning a unique identifier to each manufacturer, searching the database for a desired manufacturer, verifying that the manufacturer is authorized to access individual data, allowing a specified manufacturer to access the specified data, or allowing interaction between the manufacturer and the customer to resolve any questions.

The system can work with the service provider site being the central focus, in which case the customer would choose a manufacturer, tailor, or merchant from the service provider site. Alternatively, the system can work for customers who go directly to a manufacturer, tailor, or merchant and then authorize the manufacturer, tailor, or merchant to access their data stored at a service provider data center. The customer and the manufacturer, tailor, or merchant may communicate directly in this scenario.

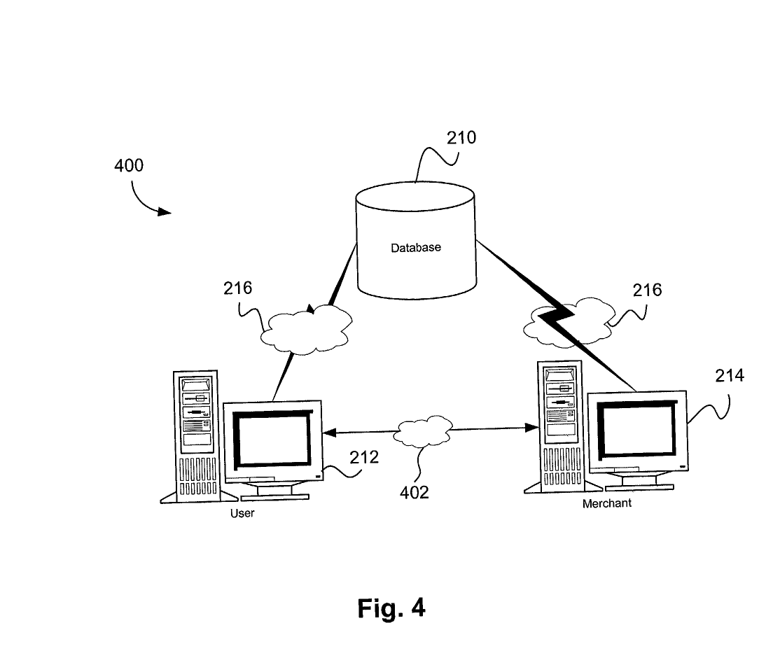

FIG. 4 is a schematic diagram illustrating a process 400 for allowing communication between the merchant and the user in accordance with an embodiment of the present invention. A database 210 includes body dimension data associated with the user. Several other types of data may also be included in the database 210, such as data associated with the merchant, unique identifier data associated with the merchant or user, etc. The merchant 214 or the user 212 may access the database 210 in order to access the data therein. Access to the database 210 may be achieved over a network 216. As previously discussed, this network 216 may be a WAN, LAN, VPN, etc. The merchant 214 may send an inquiry via the network 216 to the database 210. The database 210 may then route the inquiry to the user 212 via the network 216. The user 212 may respond to the inquiry via the network 216, sending the response back to the database 210 where it is then routed back to the merchant 214 via the network 216. This same process may apply when the user 212 has an inquiry for the merchant 214. As an option, the merchant 214 and the user 212 may communicate directly 402. This direct communication may be via the network or any other method of communication, such as telephone, mail, or in person. By this process, a channel for interaction between the designer, tailor, or manufacturer and the customer to clarify order details or for any other exchange of information may be created.

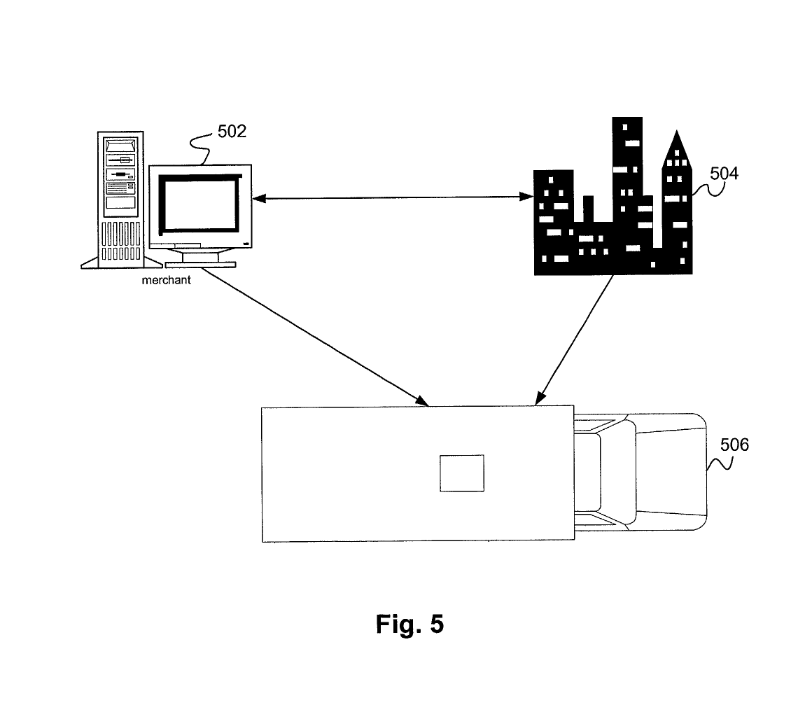

FIG. 5 is a schematic diagram illustrating a process 500 for delivery of a customized product in accordance with an embodiment of the present invention. The merchant 502 has accessed body dimension data associated with a user. The merchant 502 may create the customized product for the user and send the product to the user via a deliverer 506. The deliverer 506 may deliver the product directly to the user, to a center where users pick up deliveries, or to a brick and mortar establishment where the user may go to retrieve the product. As an option, the merchant may send the body dimension data or instructions for manufacturing the product to a manufacturer 504. The manufacturer 504 may then make the product and send the product to the user via the deliverer 506. As another option, the merchant 502 may send the body dimension data or instructions for manufacturing the product to the manufacturer 504 who may then send the product back to the merchant 502. The merchant 502 may then send the product to the user via a deliverer 506 or the user may retrieve the product from the merchant 502.

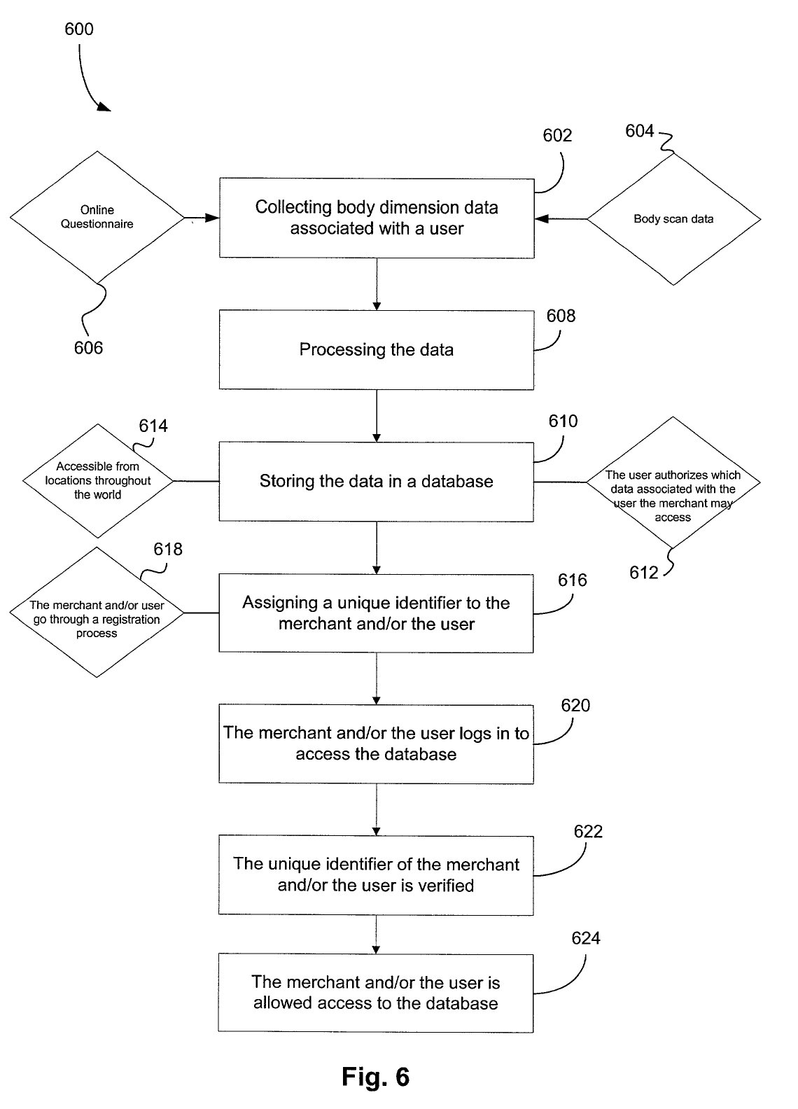

FIG. 6 is a flowchart illustrating a process 600 for restricting access to the database in accordance with an embodiment of the present invention. In operation 602, body dimension data associated with a user is collected. This data may be body scan data 604 or data collected from an online questionnaire 606. The data is processed in operation 608. In operation 610, this data is stored in a database. As an option, the user may authorize which of the collected data associated with the user the merchant may access 612 from this database. This database may be accessible from locations throughout the world 614. In operation 616, the merchant or the user may be assigned a unique identifier in order to access the database. The merchant or the user may go through a registration process 618 in order to receive this unique identifier. In operation 620, the merchant or the user may log in to access the database. Once the merchant or the user has logged in, the unique identifier may be verified in operation 622. In operation 624, the merchant or the user is allowed access to the database once the unique identifier has been presented and verified in the preceding operations.

The database and the software can enable designers, tailors, or manufacturers, who are part of the network, to receive accurate body measurements, and to interact with customers who may be in the same or different locations. It can greatly reduce room for human error and inaccuracies while measuring customers. It may be interactive, accurate, efficient, and globally accessible. Consequently, it can allow for mass customization of apparel, footwear, and other items with accuracy, efficiency and universal accessibility.

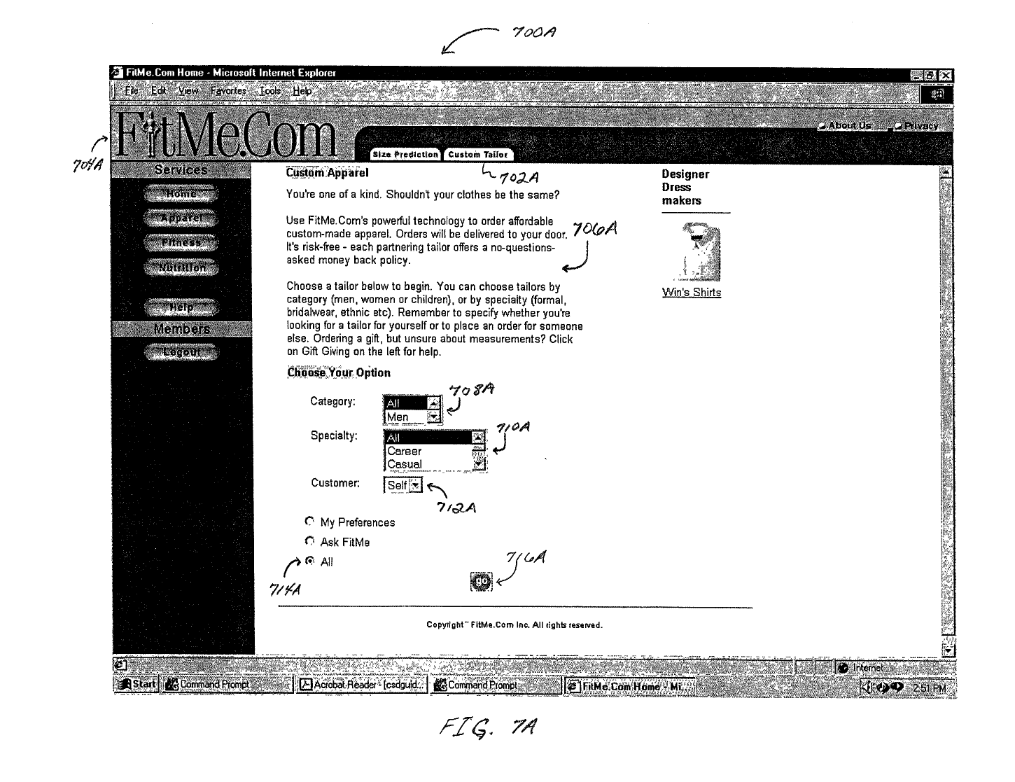

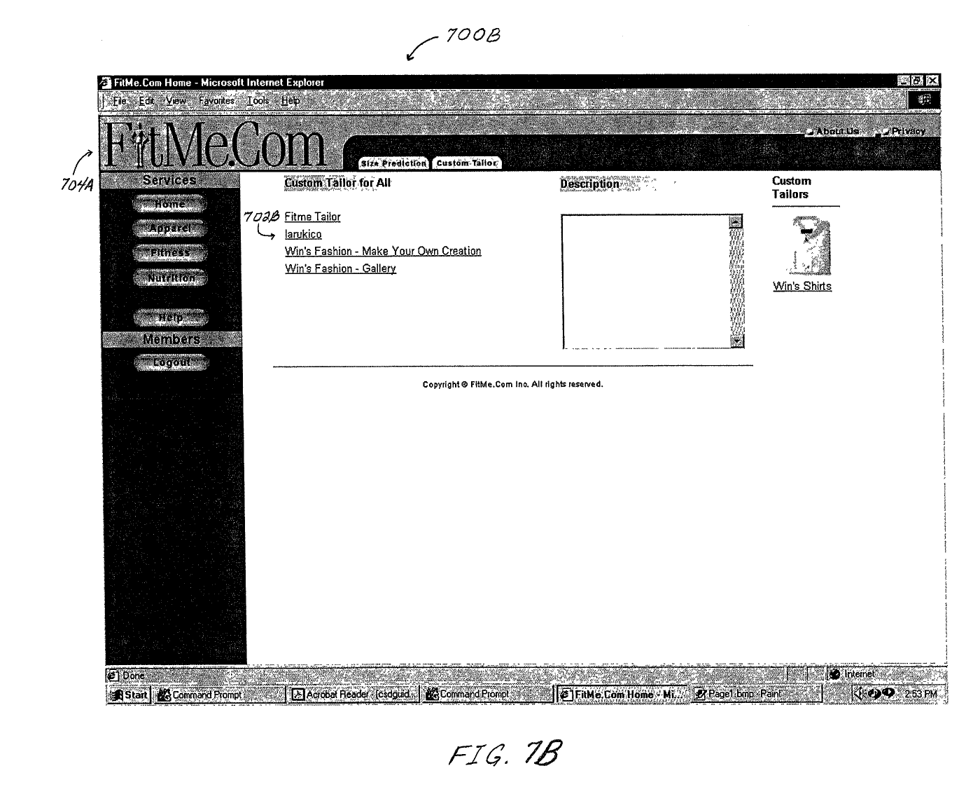

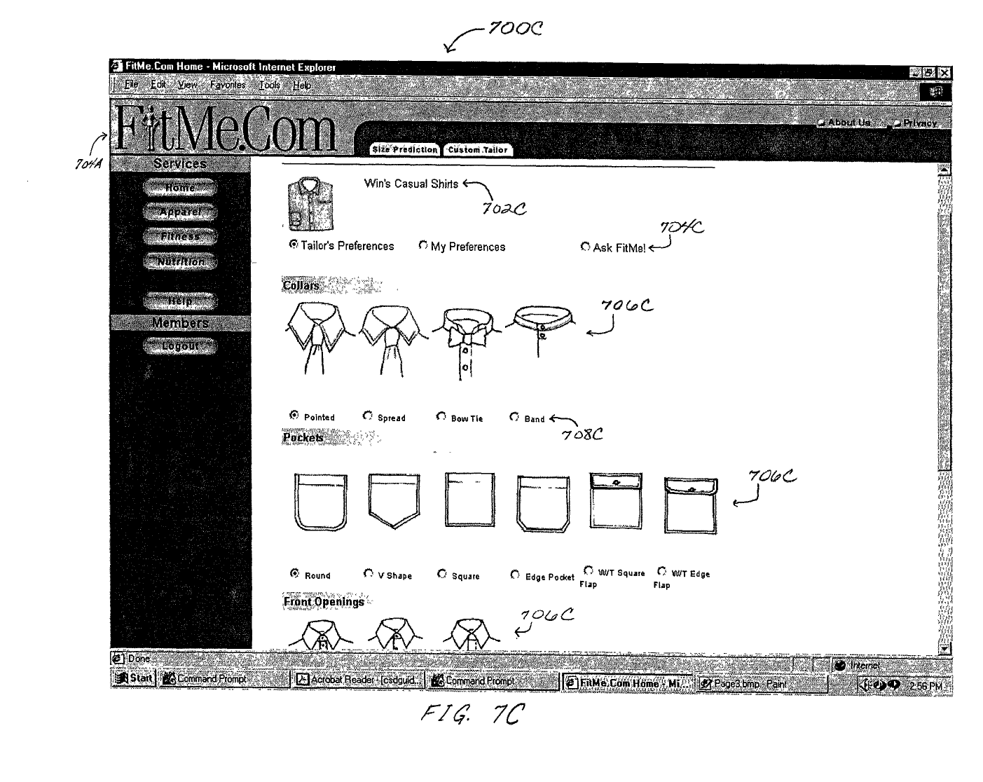

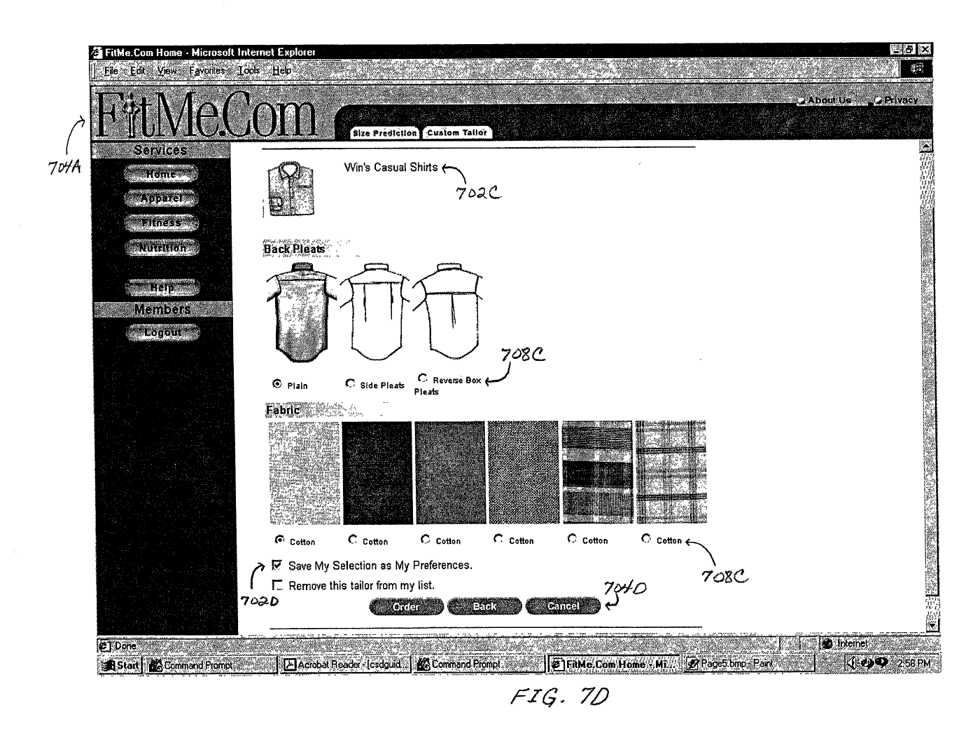

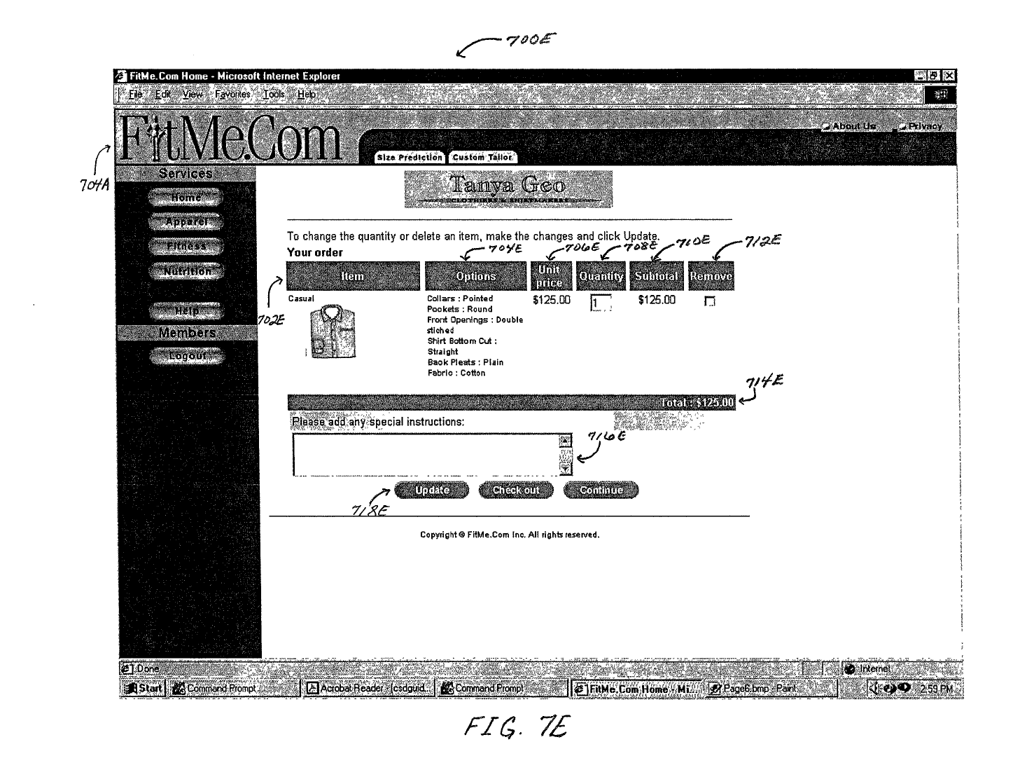

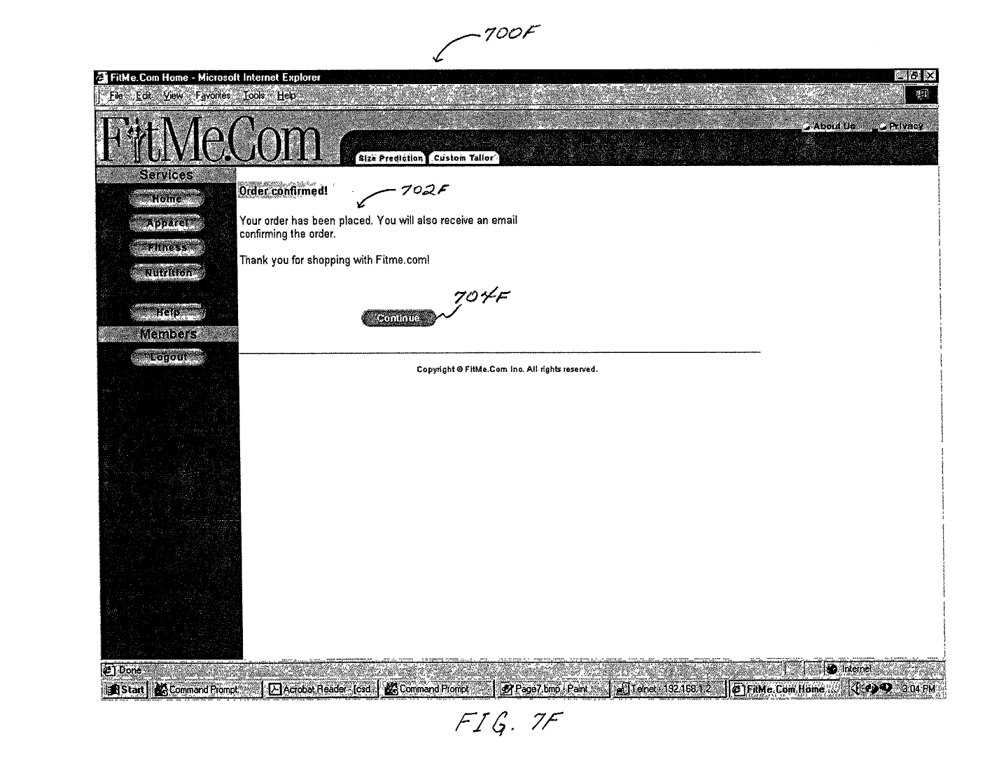

FIG. 7A is a screen capture showing a custom tailoring display 700A in accordance with an embodiment of the present invention. The screen shot 700A may include various tabs 702A, representing categories of services offered by the service provider 704A. A brief description 706A of benefits or services offered by the category of service may be provided. In addition, a category 708A and specialty 710A of tailors may be selected. These options fall under the “choose your option” heading. A customer 712A may also be selected. Display items may be selected as well. For example, the current screen shot 700A indicates that “All” 714A has been selected for display. The user may hit the go key 716A to continue.

FIG. 7B is a screen capture showing a user selected display item 700B in accordance with an embodiment of the present invention. A list of custom tailor for All 702B is displayed. The user may select a tailor from the list 702B.

FIGS. 7C and 7D are screen captures showing custom tailor information 700C in accordance with an embodiment of the present invention. A tailor from the list of tailors 702B in FIG. 7B has been selected in the present screen capture. The tailor selected is displayed at the top of the display 702C. In this display, information related to Win's casual shirts is displayed. The user may choose from several preferences 704C that may be associated with parts or aspects of the shirt. In the present display, the user has chosen the tailor's preferences. Various parts or aspects of the shirt 706C include options associated therewith. Thus, the user may choose from various features 708C associated with the various parts or aspects of the shirt 706C. For instance, the user may opt for the pointed feature associated with the collared part of the shirt in the present screen capture. Similarly, in FIG. 7D, where the current screen shot is continued, the user may choose plain back pleats, side back pleats, etc. associated with the back pleat part of the shirt. The user may also choose the type of fabric (i.e. fabric feature) associated with the fabric aspect of the shirt in the present screen capture. FIG. 7D also illustrates the display of memory options 702D. For example, the user in the screen shot illustrated in FIG. 7D may choose to save the selection or remove the tailor from the list of the user. The user may hit a button 704D at the bottom of the display to end or continue the session.

FIG. 7E is a screen capture showing a custom tailoring order summary 700E in accordance with an embodiment of the present invention. Near the top of the display, categories related to the order of the user are presented. The item 702E ordered is displayed. A column displaying options 704E selected by the user is located in the next column in the present screen capture. In the column to the right of the options column 704E, is a column displaying the unit price 706E of the item selected by the user. The quantity 708E selected by the user is displayed in the next column. The subtotal 710E of the item(s) ordered by the user is displayed. In the last column, an option to remove 712E is displayed to the user.

Near the bottom of the display, the total 714E for all of the items in the above columns is displayed. A comment box 716E is displayed under the total 714E in the present screen capture. The user may add comments or special instructions in the comment box 716E. Near the bottom of the page, option buttons 718E related to the order of the user are displayed. The user may select these option buttons 718E to update, check out, or continue with the ordering process.

FIG. 7F is a screen capture showing a custom tailoring confirmation page 700F in accordance with an embodiment of the present invention. A confirmation message 702F is displayed near the top of the display. The confirmation message 702F may include information confirming the order, as well as information regarding communications that can include order details. The bottom of the display includes a continue key 704F in the present screen capture. The user may click the continue key 704F to return to the home page.

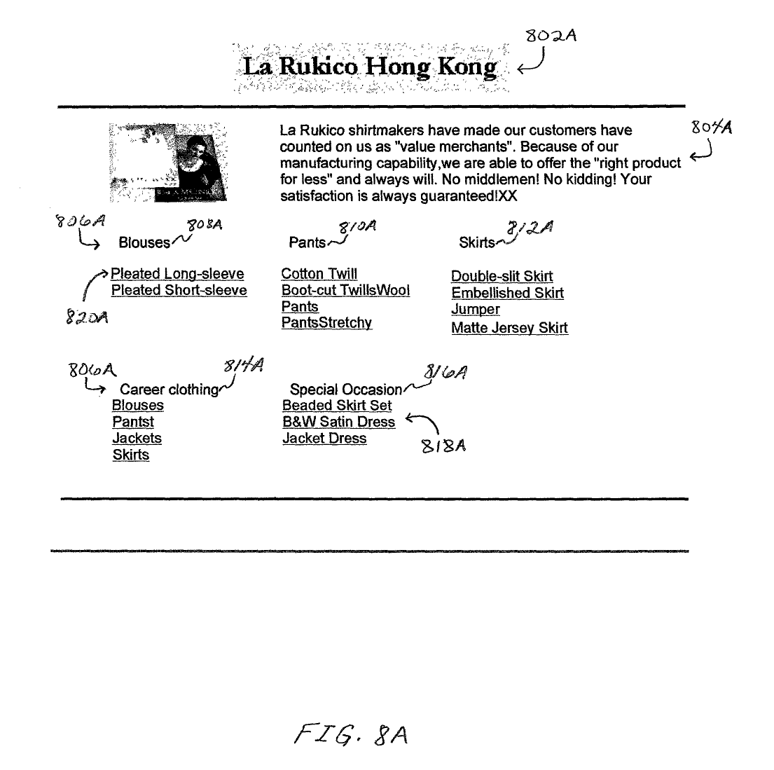

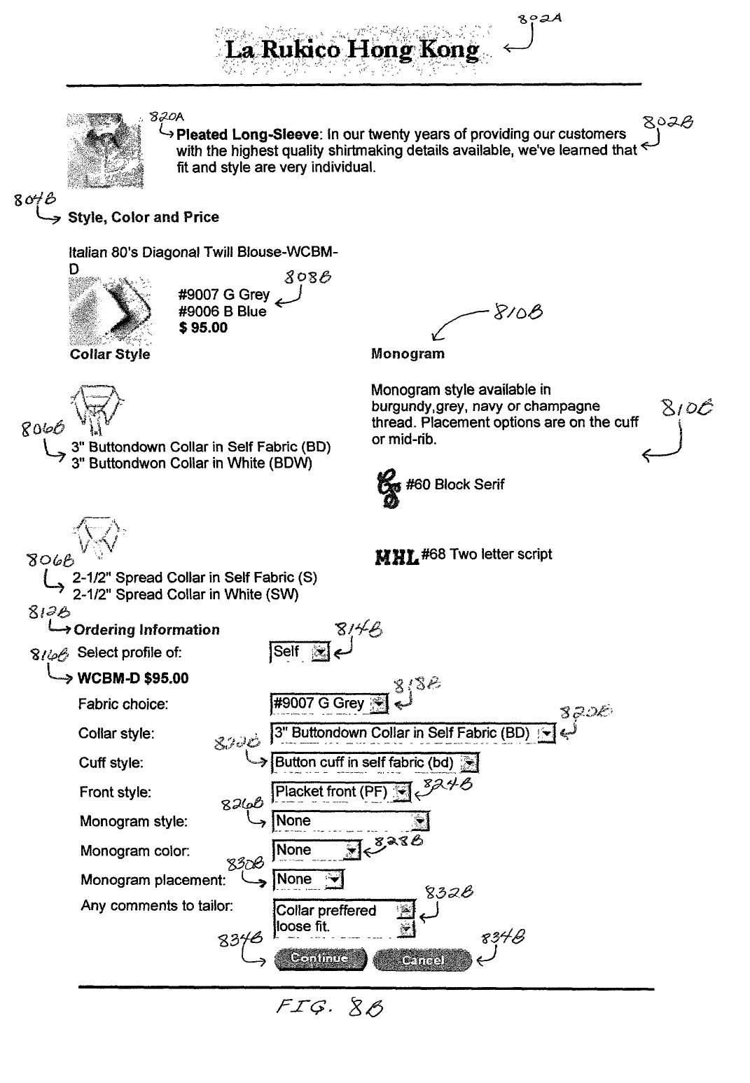

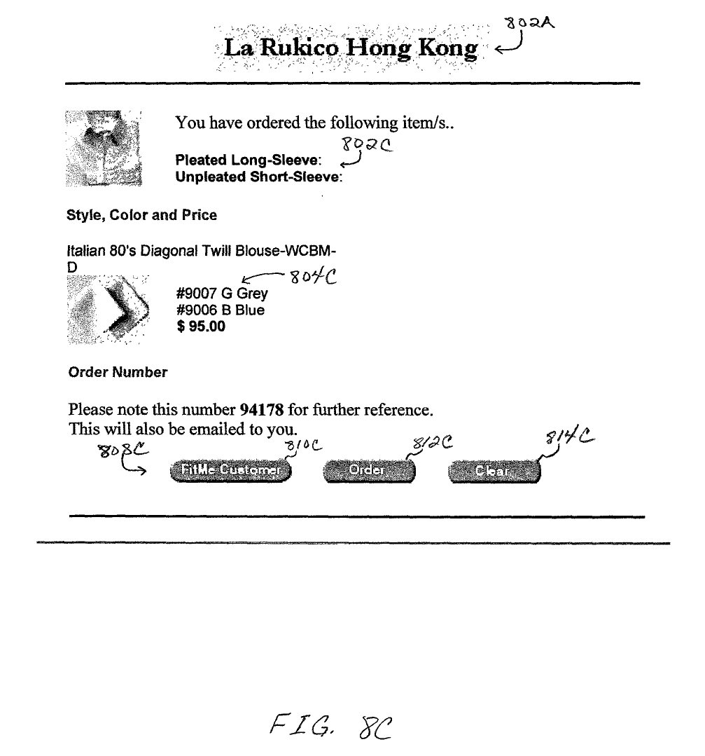

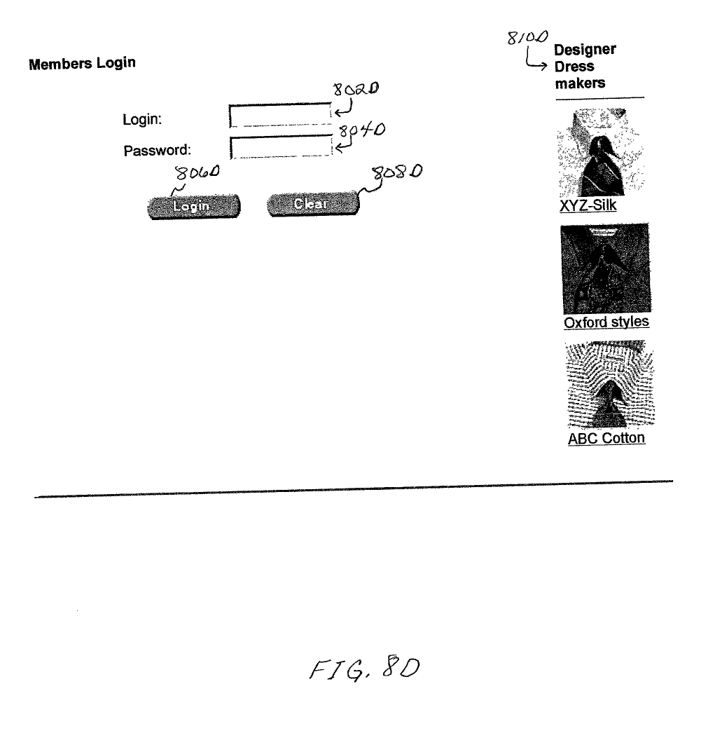

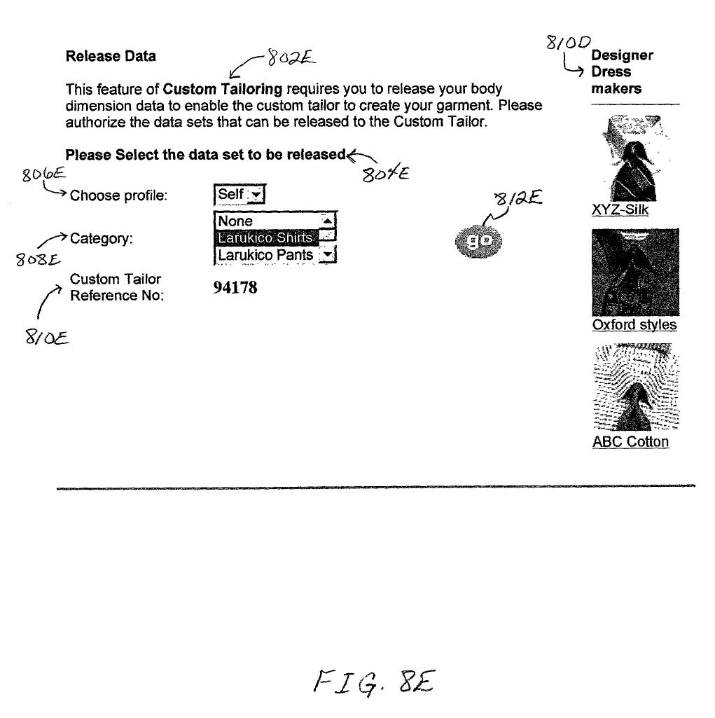

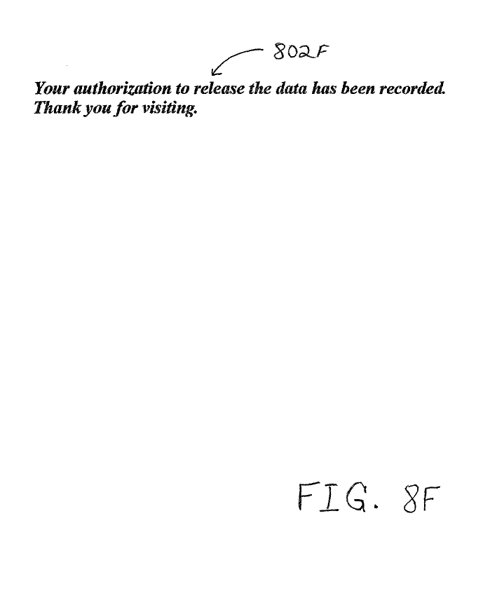

FIGS. 8A-8F are screen captures showing an order from a custom tailor. When a customer clicks on a tailor, the customer may be redirected to the custom tailor's website. The custom tailor may be a partially cooperating custom tailor (PCCT) of the service provider. The customer may order a garment from the custom tailor site as if they were not a service provider customer. Otherwise, they may order a garment as a service provider customer. FIG. 8A is a screen capture showing a web page of a custom tailor. The tailor's name and location 802A are displayed at the top of the page. Below this display, a brief paragraph 804A about the tailor is displayed. In the two rows, categories of clothing 806A are displayed. The categories in the present screen capture include blouses 808A, pants 810A, skirts 812A, career clothing 814A, and special occasion 816A. Each category 806A includes a column of clothing types 818A associated with the category 806A. For example, pleated long-sleeve 820A is a type of blouse in the blouse category 808A.

FIG. 8B is a screen capture showing a user selected display item in accordance with an embodiment of the present invention. Here, pleated long-sleeve 820A has been chosen. A brief paragraph 802B associated with the category is displayed. A style, color and price heading 804B is displayed near the top of the page. Collar styles and fabric and color are displayed 806B. Style numbers, colors, and price are also displayed 808B. The current screen capture also displays monogram options 810B. Near the bottom of the page, ordering information 812B is displayed. The ordering information in the current screen capture may include a selected profile 814B, a price 816B, a fabric choice 818B, a collar style 820B, a cuff style 822B, a front style 824B, a monogram style 826B, a monogram color 828B, a monogram placement 830B, or comments to the tailor 832B. Near the bottom of the current screen capture, buttons 834B are displayed to the user to allow the user to decide whether to proceed with the order.

FIG. 8C is a screen capture showing an order confirmation and display in accordance with an embodiment of the present invention. The type of item ordered 802C is displayed near the top of the page. The style, color and price of the item 804C is also displayed on the page. Near the bottom of the page, the order number and brief message is displayed 806C to the user. At the bottom of the current screen capture, the user may choose from one of a plurality of buttons 808C. The buttons 808C allow the user to order the item utilizing custom fit measurements from the service provider 810C, order the item through the tailor 812C, or clear the order 814C.

FIG. 8D is a screen capture showing a login page for a user selecting to order the item utilizing the custom fit measurements from the service provider in accordance with an embodiment of the present invention. The current screen capture provides a login space 802D and a space in which to enter a password 804D. The user may select the buttons to login 806D or clear 808D the login page. Also displayed on the current screen capture are links to other merchants, such as designer dress makers 810D.

FIG. 8E is a screen capture showing an authorization page in accordance with an embodiment of the present invention. Near the top of the page is an explanatory paragraph 802E requesting that the user authorizes release of the user data (i.e. custom fit measurements). The current screen capture allows the user to authorize which data set may be released to the tailor 804E. The user may choose a user profile 806E and category 808E. A custom tailor reference number 810E is also displayed on the page. The user may click on the go button 812E to authorize release of the data selected by the user for release.

FIG. 8F is a screen capture showing a confirmation message in accordance with an embodiment of the present invention. The confirmation message 802F confirms that the authorization to release the data has been recorded.

The present invention can allow for scientific accuracy and ease of use, as well as efficiency. It can eliminate the possibility of human error. A comprehensive body dimension system is provided that may be easily accessible from any location in the world, and can be interactive as well. The customer may be provided with the opportunity for seamless interaction with the designer, tailor, or manufacturer.

The present invention enables mass customization of apparel, footwear and other lifestyle-related applications on a global scale. By using the present invention, designers, tailors, or manufacturers who produce items in smaller batches may not be constrained by the necessity to be in the same geographic location as the customer to get body measurements. It can avoid the possibility of inaccurate measurements which often compels customers to schedule repeated fitting sessions. Furthermore, it can satisfy the need for an accurate, efficient, and global method of interaction between designers, tailors, or manufacturers and individual customers.

With respect to accuracy, the system may be extremely accurate since it is based on a commercially viable system utilizing 3-D body scanners to generate accurate body measurements. Customers who do not have access to the body scanners may have the ability to add their information to the database by carefully answering questions about their body measurements. The software can update the database, keeping track of changes in body measurements, either through repeated scans or through changes input by the user, and by storing knowledge about a customer's individual fit preferences.

With respect to efficiency, the system may be very efficient. Designers, tailors, or manufacturers using the present invention can have swift access to customer data to manufacture and deliver partial or complete custom-made clothes and footwear in batches as small as one or as large as in several hundred thousands. The body dimension system can have the ability to enable mass customization for customers regardless of geographic location. The network and proprietary software can empower tailors, manufacturers, or designers to change their business emphasis to focus on the individual customer even as they produce items for the mass market.

Designers, tailors, or manufacturers may receive orders from, and interact with, customers throughout the globe. This can save time, money, and frustration for both customers and designers, tailors, or manufacturers by helping creation of products that are customized taking individual dimensions and preferences into account. Furthermore, customers can be empowered by giving them the ability to customize apparel, footwear and other lifestyle-related applications. In addition, customers may have the ability to choose from designers, tailors, or manufacturers or brands and labels all over the world. Customers may also order from a catalog or gallery of creations, or to design his or her apparel, footwear, or other lifestyle-related product.

The software can suggest designers, tailors, or manufacturers that are most appropriate for a customer's body dimensions or individual preferences (for example, customers might want to locate the closest manufacturer for a specific brand, or to locate a designer or tailor who specializes in bridal wear). Designers, tailors, or manufacturers may access information on customer fit preferences and other choices, when available.

Users may order customized apparel as gifts for other individuals. An authorization process can be implemented in order to allow users to enable others to gift them apparel or footwear without revealing sizes, or personal fit preferences. The system can ensure that a user's personal information, including name, address and body measurements, remains confidential and is only shared when the user authorizes its release to a specified party. Similarly, the user may have the ability to control the level of personal information that is shared with the designer, tailor, or manufacturer (for example, a customer ordering a shirt can specify that only the measurements relevant to his order are shared with the tailor).

Apart from apparel and footwear, the system enables mass customization for other applications including, but not restricted to, custom golf clubs, custom automobile and airline seats and custom bicycles.

The present invention ensures that personal fit preferences can be an inherent part of the ordering process, and that they can be recorded and updated as often as a user wishes, with no (when a repeat scan records changed body dimensions), or minimum effort (when a user inputs any changes). It is commercially viable, making body scanners an economical method of saving time, money and effort for both consumers and the apparel, footwear, and other life-style industries.

Consequently, designers, tailors, or manufacturers can greatly benefit from the present invention. Designers, tailors, or manufacturers can increase sales of their products by customizing their apparel, footwear, or other lifestyle-related items. Designers, tailors, or manufacturers can increase sales by increasing their visibility and customer base worldwide, as well as improve the bottom line by reducing the rate of returns.

Other benefits may include freeing resources for designers, tailors, or manufacturers by reducing the amount of time and effort spent on each order (for example, accurate measurements and understanding of individual fit preferences will do away with the need for multiple fitting sessions). The present invention can also aid designers, tailors, or manufacturers' in-depth understanding of consumer preferences and trends at the mass-market level.

In an exemplary embodiment in accordance with the present invention, a designer, tailor, or manufacturer wishing to acquire new customers and access their data through the system of the present invention, registers to be a user of the system. The registering designer, tailor, or manufacturer can create online page(s) within the web site, displaying abilities and creations or sample garments. Alternatively, the designer, tailor, or manufacturer can ask for a link to their website. Designers, tailors, or manufacturers can give customers the ability to design garments (e.g. provide choices about the collar, pocket, etc., for customers who wish to order shirts). Each designer, tailor, or manufacturer may be assigned a unique identifier.

Users may go through the scan process at the scan sites. Body measurements generated through the scan can be sent through the network into the database. Alternatively, users can input their measurements into the database by answering a detailed online questionnaire, or by other methods aimed at obtaining accurate body dimensions of the user.

Each individual user may be assigned a unique identifier. Individual data is stored in the database. The user who wishes to place a custom order can locate a designer, tailor, or manufacturer by region or specialty (men, women, ethnic etc.) or other choices. The user can request a suggestion of the most appropriate designer, tailor, or manufacturer depending on body type, location, or specialty or other preferences. The user can choose an item from a designer, tailor, or manufacturer's online catalog or display of past creations, samples, or specialties. The user can also design his or her own garment from a set of choices provided by each designer, tailor, or manufacturer.

The user can also add any special requirements or additional comments in the online order form. The user can specify the level of data to be shared with the designer, tailor, or manufacturer (for example, he or she can release complete body data for a suit, but authorize release of only partial data if only a shirt is being ordered). Once the order is placed, an email may be sent to the designer, tailor, or manufacturer with details of the order. The designer, tailor, or manufacturer can log in to access the database, using the assigned unique identifier.

Using a specific order number, the designer, tailor, or manufacturer can access the user's body data to the level specified by the user. The designer, tailor, or manufacturer can update the order status after downloading (i.e. accessing) the relevant user data.

The designer, tailor, or manufacturer can then send questions, if any, about the data to the database administrator. The designer, tailor, or manufacturer can also send questions about the order specifications to the database, which routes the inquiry to the user. The user's reply, in turn, may be routed back to the tailor. The designer, tailor, or manufacturer can send the finished garment to the user, or to any other location that will deliver the finished product to the user or intended recipient. The body dimension data and online software can create a database that enables the mass customization of products. Products that may be mass-customized utilizing this process can include apparel, footwear, and other lifestyle-related applications, such as sporting equipment and seats.

The present invention can provide a body dimension system that comprises a network of 3-D body scanners, user input measurements, or software to generate, store, or transmit individual body measurements and personal fit preferences in a globally accessible manner. It can allow for the delivery of accurate customer body dimension data to the designer, tailor, or manufacturer thereby enabling mass customization of apparel, footwear, and other lifestyle-related applications in an accurate, efficient, and interactive manner. This can be done in a manner that does not compromise customer privacy. It can be used at multiple locations worldwide, while saving customers and the industry time, money and effort.

Body dimensions may be measured and a database can be created that can be accessed by designers, tailors, or manufacturers, and customers, through an Internet-connected computer or other device such as a web-connected wireless phone from their homes, offices, stores, or any location worldwide, at any point in time. The system may allow designers, tailors, or manufacturers to get orders from, and seamlessly interact with, customers all over the globe.

Thus, the present invention can combine accurate body measurements and a knowledge of individual fit preferences with a global network that can be accessed by, and enable swift interaction between customers and designers, tailors, or manufacturers located worldwide.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

What is claimed is:

1. A method for providing mass customization of products comprising the steps of:
(a) collecting body dimension data associated with a user, wherein the body dimension data includes at least one of a plurality of measurements of at least one of a plurality of parts of a body of the user;
(b) storing the data collected in a database;
(c) processing the data collected, wherein the processing generates additional value that allows a merchant to readily use the data;
(d) storing the processed data in the database; and
(e) allowing the merchant to access the processed data in the database.

2. The method as recited in claim 1, wherein body dimension data is collected by at least one of body scanners and measurements obtained manually.

3. The method as recited in claim 2, wherein the measurements obtained manually include measurements obtained in response to a questionnaire.

4. The method as recited in claim 1, wherein the merchant accesses the processed data in the database utilizing a user order number received through a communication associated with an order of the user.

5. The method as recited in claim 1, further comprising at least one of:
allowing the merchant to communicate with the user by sending a communication to the database,
routing the communication from the database to the user,
allowing the user to reply to the communication, and
routing the reply to the merchant.

6. The method as recited in claim 1, wherein the processed data accessed by the merchant is utilized to update the status of an order by the user.

7. The method as recited in claim 1, further comprising adding to an order of the user at least one of special requirements, comments, a description of a product, a nature of customization desired and personal fit preferences.

8. The method as recited in claim 1, wherein information associated with the merchant is collected and stored in the database.

9. The method as recited in claim 8, further comprising suggesting to the user the merchant appropriate for the services sought depending on at least one of body type, location, specialty, and user preferences.

10. The method as recited in claim 8, wherein the user searches the database for the merchant the user desires for the services sought.

11. The method as recited in claim 1, further comprising allowing the user to place an order with the merchant.

12. The method as recited in claim 1, further comprising updating the database based on at least one of:
body dimension data from a repeat body scan,
body measurements obtained manually, and
individual fit preferences.

13. The method as recited in claim 1, wherein the database is a centralized database accessible from locations throughout the world.

14. The method as recited in claim 1, further comprising assigning a unique identifier to at least one of the user and the merchant to allow access to the database.

15. The method as recited in claim 14, wherein at least one of the user and the merchant are allowed to access the database by presenting the unique identifier.

16. The method as recited in claim 14, wherein which of the plurality of measurements the merchant can access from the database is verified upon presentation of the unique identifier of the merchant.

17. The method as recited in claim 14, wherein at least one of the user and the merchant go through a registration process in order to receive the unique identifier.

18. The method as recited in claim 1, further comprising allowing the user to authorize which of the plurality of measurements the merchant can access from the database.

19. A computer program embodied on a computer readable medium for providing mass customization of products comprising the steps of:
(a) a code segment that collects body dimension data associated with a user, wherein the body dimension data includes at least one of a plurality of measurements of at least one of a plurality of parts of a body of the user;
(b) a code segment that stores the data collected in a database;
(c) a code segment that processes the data collected, wherein the processing generates additional value that allows a merchant to readily use the data;
(d) a code segment that stores the processed data in the database; and
(e) a code segment that allows the merchant to access the processed data in the database.

20. The computer program as recited in claim 19, wherein body dimension data is collected by at least one of body scanners and measurements obtained manually.

21. The computer program as recited in claim 20, wherein the measurements obtained manually include measurements obtained in response to a questionnaire.

22. The computer program as recited in claim 19, wherein the merchant accesses the processed data in the database utilizing a user order number received through a communication associated with an order of the user.

23. The computer program as recited in claim 19, further comprising at least one of:
a code segment that allows the merchant to communicate with the user by sending a communication to the database,
a code segment that routes the communication from the database to the user,
a code segment that allows the user to reply to the communication, and
a code segment that routes the reply to the merchant.

24. The computer program as recited in claim 19, wherein the processed data accessed by the merchant is utilized to update the status of an order by the user.

25. The computer program as recited in claim 19, further comprising a code segment that adds to an order of the user at least one of special requirements, comments, a description of a product, a nature of customization desired and personal fit preferences.

26. The computer program as recited in claim 19, wherein information associated with the merchant is collected and stored in the database.

27. The computer program as recited in claim 26, further comprising a code segment that suggests to the user the merchant appropriate for the services sought depending on at least one of body type, location, specialty, and user preferences.

28. The computer program as recited in claim 26, wherein the user searches the database for the merchant the user desires for the services sought.

29. The computer program as recited in claim 19, further comprising a code segment that allows the user to place an order with the merchant.

30. The computer program as recited in claim 19, further comprising a code segment that updates the database based on at least one of:
body dimension data from a repeat body scan,
body measurements obtained manually, and
individual fit preferences.

31. The computer program as recited in claim 19, wherein the database is a centralized database accessible from locations throughout the world.

32. The computer program as recited in claim 19, further comprising a code segment that assigns a unique identifier to at least one of the user and the merchant to allow access to the database.

33. The computer program as recited in claim 32, wherein at least one of the user and the merchant are allowed to access the database by presenting the unique identifier.

34. The computer program as recited in claim 32, wherein which of the plurality of measurements the merchant can access from the database is verified upon presentation of the unique identifier of the merchant.

35. The computer program as recited in claim 32, wherein at least one of the user and the merchant go through a registration process in order to receive the unique identifier.

36. The computer program as recited in claim 19, further comprising a code segment that allows the user to authorize which of the plurality of measurements the merchant can access from the database.

37. A system for providing mass customization of products comprising the steps of:
(a) a server computer;
(b) a database, stored on the server computer, including body dimension data associated with a user, wherein the body dimension data includes at least one of a plurality of measurements of at least one of a plurality of parts of a body of the user;
(c) logic that processes the body dimension data associated with the user, wherein the processing generates additional value that allows a merchant to readily use the data;
(d) logic that stores the processed data in the database; and
(e) logic that allows the merchant to access the processed data in the database.

38. The system as recited in claim 37, wherein body dimension data is collected by at least one of body scanners and measurements obtained manually.

39. The system as recited in claim 38, wherein the measurements obtained manually include measurements obtained in response to a questionnaire.

40. The system as recited in claim 37, wherein the merchant accesses the data in the database utilizing a user order number received through a communication associated with an order of the user.

41. The system as recited in claim 37, further comprising at least one of: logic that allows the merchant to communicate with the user by sending a communication to the database, logic that routes the communication from the database to the user, logic that allows the user to reply to the communication, and logic that routes the reply to the merchant.

42. The system as recited in claim 37, wherein the data accessed by the merchant is utilized to update the status of an order by the user.

43. The system as recited in claim 37, further comprising logic that adds to an order of the user at least one of special requirements, comments, a description of a product, a nature of customization desired and personal fit preferences.

44. The system as recited in claim 37, wherein information associated with the merchant is collected and stored in the database.

45. The system as recited in claim 44, further comprising logic that suggests to the user the merchant appropriate for the services sought depending on at least one of body type, location, specialty, and user preferences.

46. The system as recited in claim 44, wherein the user searches the database for the merchant the user desires for the services sought.

47. The system as recited in claim 37, further comprising logic that allows the user to place an order with the merchant.

48. The system as recited in claim 37, further comprising logic that updates the database based on at least one of: body dimension data from a repeat body scan, body measurements obtained manually, and individual fit preferences.

49. The system as recited in claim 37, wherein the database is a centralized database accessible from locations throughout the world.

50. The system as recited in claim 37, further comprising logic that assigns a unique identifier to at least one of the user and the merchant to allow access to the database.

51. The system as recited in claim 50, wherein at least one of the user and the merchant are allowed to access the database by presenting the unique identifier.

52. The system as recited in claim 50, wherein which of the plurality of measurements the merchant can access from the database is verified upon presentation of the unique identifier of the merchant.

53. The system as recited in claim 50, wherein at least one of the user and the merchant go through a registration process in order to receive the unique identifier.

54. The system as recited in claim 37, further comprising logic that allows the user to authorize which of the plurality of measurements the merchant can access from the database.
